(19) United States
(12) Patent Application Publication
(10) Pub. No.: US 2025/0111103 A1
(43) Pub. Date: Apr. 3, 2025

(54) DESIGN SUPPORT DEVICE

(71) Applicant: Hitachi, Ltd., Tokyo (JP)

(72) Inventors: Yuuki SHIMIZU, Tokyo (JP); Erika Watanabe, Tokyo (JP)

(21) Appl. No.: 18/887,569

(22) Filed: Sep. 17, 2024

(30) Foreign Application Priority Data
Sep. 28, 2023 (JP) 2023-167140

(51) Int. Cl. G06F 30/20

(52) U.S. Cl. CPC G06F 30/20

(57) ABSTRACT

Provided is a design support device capable of effectively utilizing defect knowledge in design work and reducing man-hours required for precise examination of a presented analysis result and variation depending on an individual user. A design support device that evaluates a defect that can occur in a design model generated by a design tool and a factor of the defect is configured to include a causal model database that stores a causal model expressing a defect that can occur in a design target by using a causal relationship in which, due to a certain phenomenon, another phenomenon occurs, an attribute information extraction unit that extracts attribute information regarding a design target from the design model, and a relevance degree evaluation unit that extracts, for the causal model, a causal relationship including a content matching with the extracted attribute information as a causal relationship having a high relevance degree to the design model.

### CLAIM OF PRIORITY

The present application claims priority from Japanese Patent application serial no. 2023-167140, filed on Sep. 28, 2023, the content of which is hereby incorporated by reference into this application.

### TECHNICAL FIELD

The present invention relates to a design support device utilizing defect information.

### BACKGROUND ART

In the manufacturing industry, efforts have been made to improve reliability by taking measures to identify possible failure modes at the design stage. As one of methods for this, there are fault tree analysis (FTA) and failure mode and effects analysis (FMEA). FTA is an analysis technique in which a defect event of a product is taken up, and failure factors thereof are sequentially identified and developed in a hierarchical manner to systematically search for an occurrence source of a failure.

This analysis result has a tree structure in which the defect event of the product is set at the top and the failure factor thereof is set at a lower level. The analysis result having this tree structure is referred to as a failure tree. The defect event of the product to be analyzed is referred to as a top event because the failure event is located at the top of the failure tree. In the failure tree, a factor at a lower level than the top event is referred to as an intermediate event.

In FMEA, at the time of design, a phenomenon related to a possible defect is predicted for a component as a design target, an influence of the phenomenon on a unit and an influence of the phenomenon on a higher-level product are evaluated, and a measure for the phenomenon having a large influence is taken in advance, thereby preventing a defect.

In the related art, this type of invention has been disclosed in, for example, PTL 1 (JP 2017-111657 A).

### CITATION LIST

### Patent Literature

PTL 1: JP 2017-111657 A

### SUMMARY OF INVENTION

### Technical Problem

PTL 1 discloses a device that supports FTA and FMEA by extracting a causal relationship of defects from past defect knowledge and presenting defect factors based on the extracted causal relationship. However, in a case where FTA or FMEA is not implemented in design work, or in a case where the number of times of implementation is small, it is not possible to effectively utilize the defect knowledge accumulated from the past.

In addition, in PTL 1, in a case where a large number of defect factors are presented, there is a concern that it takes time to precisely examine the causal factors, or a result thereof varies depending on an individual user who precisely examines the causal factors.

Therefore, the present invention provides a design support device capable of utilizing defect knowledge in design work and reducing man-hours required for precise examination of an analysis result and variation depending on an individual user.

### Solution to Problem

In order to solve the above-described problems, the present invention provides a design support device that evaluates a defect that can occur in a design model generated by a design tool and a factor of the defect. The design support device is configured to include a causal model database that stores a causal model expressing a defect that can occur in a design target by using a causal relationship in which, due to a certain phenomenon, another phenomenon occurs, an attribute information extraction unit that extracts attribute information regarding a design target from the design model, and a relevance degree evaluation unit that extracts, for the causal model, a causal relationship including a content matching with the extracted attribute information as a causal relationship having a high relevance degree to the design model.

### Advantageous Effects of Invention

Defect knowledge in design work is effectively utilized, and man-hours required for precise examination of an analysis result and variation depending on an individual user are reduced. Objects, configurations, and advantageous effects other than those described above will be clarified by the descriptions of the following forms for embodying the present invention.

### BRIEF DESCRIPTION OF DRAWINGS

FIG. 1 is a diagram for describing a configuration of a design support device according to Example 1.

FIG. 2 is a diagram illustrating a form of a causal model.

FIG. 3 is a diagram illustrating a specific example of the causal model.

FIG. 4 is a diagram for describing processing of presenting a causal relationship having a high relevance degree to a target product.

FIG. 5A is a diagram illustrating a specific example of the causal model.

FIG. 5B is a diagram for describing processing of presenting a causal relationship having a high relevance degree to a target product.

FIG. 6A is a diagram illustrating a specific example of the causal model.

FIG. 6B is a table example of an importance degree evaluation unit.

FIG. 7A is a screen display example of an evaluation result.

FIG. 7B is another screen display example of the evaluation result.

FIG. 8 is a diagram for describing a configuration of a design support device according to Example 2.

FIG. 9 is a diagram illustrating an example of an FMEA table.

FIG. 10 is a diagram illustrating a specific example of a causal model.

FIG. 11 is a diagram for describing a configuration of a design support device according to Example 3.

### DESCRIPTION OF EMBODIMENTS

Hereinafter, an embodiment of the present invention will be described with reference to the drawings. Examples are for describing the present invention, and are omitted and simplified as appropriate for clarity of description. The present invention can be implemented in various other forms. Unless otherwise specified, each constituent element may be singular or plural.

Positions, sizes, shapes, ranges, and the like of the constituent elements illustrated in the drawings are provided to facilitate understanding of the invention and may not represent actual positions, sizes, shapes, ranges, and the like. Therefore, the present invention is not necessarily limited to the positions, sizes, shapes, ranges, and the like illustrated in the drawings.

Examples of various types of information may be described in terms of expressions such as “table”, but various types of information may be expressed in a data structure other than the above expressions. For example, various types of information such as “XX table” may be set to “XX information”. In describing identification information, expressions such as “identification information”, “identifier”, “name”, “ID”, and “number” are used, but the expressions can be replaced with each other. In a case where there is a plurality of constituent elements having the same or similar functions, the same reference signs may be denoted with different subscripts for description. In addition, in a case where it is not necessary to distinguish the plurality of constituent elements, the description may be made by omitting the subscript.

In the examples, processing performed by executing a program may be described. Here, the computer executes a program by a processor (for example, a CPU and a GPU), and performs processing defined by the program using a storage resource (for example, a memory), an interface device (for example, a communication port), and the like.

Therefore, the subject of the processing performed by executing the program may be a processor. Similarly, the subject of the processing performed by executing the program may be a controller, a device, a system, a computer, or a node having a processor.

The subject of the processing performed by executing the program may be an arithmetic unit, and may include a dedicated circuit that performs specific processing. Here, the dedicated circuit is, for example, a field programmable gate array (FPGA), an application specific integrated circuit (ASIC), a complex programmable logic device (CPLD), or the like.

The program may be installed on the computer from a program source. The program source may be, for example, a program distribution server or a computer-readable storage medium.

In a case where the program source is a program distribution server, the program distribution server may include a processor and a storage resource that stores a distribution target program, and the processor of the program distribution server may distribute the distribution target program to another computer.

In the embodiments, two or more programs may be implemented as one program, or one program may be implemented as two or more programs.

### Outline

In hardware design, the structure of a product is designed by using a three-dimensional CAD system (3D CAD) in many cases. Therefore, in the embodiment of the present invention, a scene in which design is performed by 3D CAD is set as a target, and attribute information regarding a product as a design target such as a characteristic shape and attribute information is extracted for a model (3D CAD model) designed by 3D CAD, the extracted attribute information is compared with a causal relationship of a defect defined in advance, a relevance degree and an importance degree are evaluated, and a defect factor having a high relevance degree or high importance degree is narrowed down and presented.

Here, in a case where design is performed by using other models such as a dependency structure matrix (DSM), a quality function deployment (QFD), and a model-based systems engineering (MBSE) model in addition to 3D CAD, attribute information may be extracted from these models and a defect factor having a high relevance degree or high importance degree may be narrowed down and presented.

### Example 1

### Device Configuration

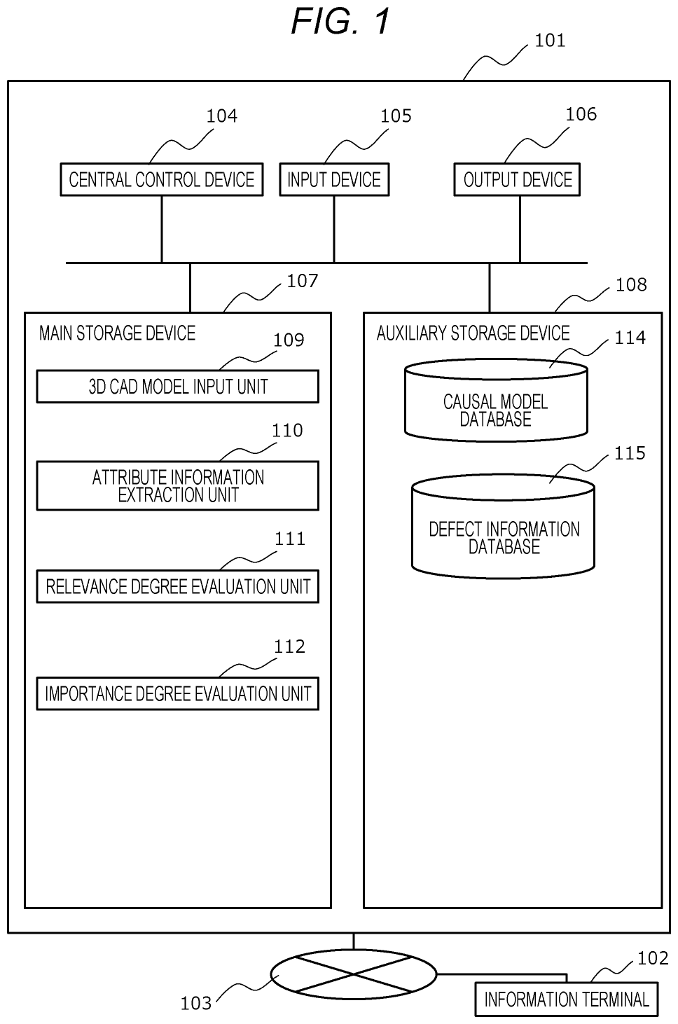

A configuration of a design support device in the present example will be described with reference to FIG. 1.

A design support device 101 is a general computer, and includes a central control device 104, an input device 105, an output device 106, a main storage device 107, and an auxiliary storage device 108, which are connected to each other by a bus or the like.

Furthermore, the design support device 101 is connected to one or a plurality of information terminals 102 via a network 103. One or a plurality of users can use the design support device 101 via the information terminal 102 operated by each user. The information terminal 102 can also use a general computer, and includes a central control device, an input device, an output device, a main storage device, and an auxiliary storage device (not illustrated). Note that the user can also directly operate and use the design support device 101 without using the information terminal 102.

In the auxiliary storage device 108, a causal model that models a causal relationship of a defect is stored in a causal model database 114. In the causal model, a factor of a defect phenomenon is defined in the form of a failure tree (a detailed form of the causal model will be described later). In addition, a defect information database 115 stores defect information (what type of defect has occurred in which device (which part)?) in the form of a text, for example.

In the main storage device 107, a 3D CAD model input unit 109, an attribute information extraction unit 110, a relevance degree evaluation unit 111, and an importance degree evaluation unit 112 are programs. In a case where the subject is described as “oo unit”, it is assumed that the central control device 104 reads each program from the main storage device 107 and realizes a function (described later in detail) of each program on the main storage device.

The 3D CAD model input unit 109 receives an input of a 3D CAD model from a user. That is, when a design model (3D CAD model) obtained by performing designing with a design tool such as 3D CAD is separately input (designated) by using the input device 105 (keyboard, mouse, or the like), the design model is taken into a temporary storage area (not illustrated) of the main storage device 107.

The attribute information extraction unit 110 extracts attribute information such as a product name, a component name, an attribute name, and a characteristic shape from the 3D CAD model received by the 3D CAD model input unit 109.

The relevance degree evaluation unit 111 evaluates a relevance degree between each factor of the causal model stored in the causal model database 114 and a product as a design target based on the attribute information extracted by the attribute information extraction unit 110.

For each factor of the causal model, the importance degree evaluation unit 112 obtains what type of defect occurs in the product due to the factor by searching the causal model stored in the causal model database 114 from the cause side to the result side, and evaluates an importance from the defect occurring in the product.

Note that details of the relevance degree evaluation unit 111 and the importance degree evaluation unit 112 will be separately described.

### Causal Model

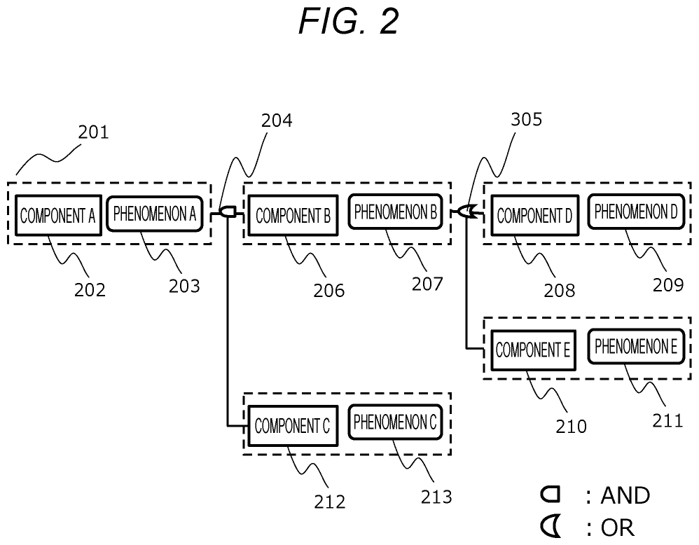

The causal model is obtained by modeling a causal relationship between a phenomenon occurring in a certain product (component) or the like and a component or the like constituting the product (component) or the like for the phenomenon occurring in the product, and enables the causal relationship of each phenomenon to be visually grasped. FIG. 2 illustrates an example of the causal model. An individual element 201 constituting the cause and effect is constituted by a component 202 and a phenomenon 203.

Note that the component 202 of the causal model indicates a target in which the phenomenon 203 occurs, and may be, for example, a method such as “heat treatment”, a characteristic shape, or a partial shape such as “edge portion”, in addition to the component. In addition, the phenomenon 203 is a phenomenon name related to a defect, such as “defective”, “hot cracking”, or “stress concentration”.

The causal model is expressed in such a manner that these elements are linked in order of causality. In the example of FIG. 2, the element on the right side may cause the element on the left side. Furthermore, as a relationship linking these elements, there are an AND condition 204 and an OR condition 205.

The AND condition 204 represents that, in a case where all elements connected to the right side thereof are generated, elements connected to the left side thereof are caused. In addition, the OR condition 205 represents that, in a case where any one of the elements connected to the right side thereof has occurred, the element connected to the left side thereof is caused.

For example, the example of FIG. 2 illustrates that a phenomenon D (209) occurs in a component D (208) or a phenomenon E (211) occurs in a component E (210), whereby a phenomenon B (207) occurs in a component B (206). The example of FIG. 2 further illustrates that the phenomenon B (207) occurs in the component B (206) and a phenomenon C (213) occurs in a component C (212), whereby a phenomenon A (203) occurs in a component A (202).

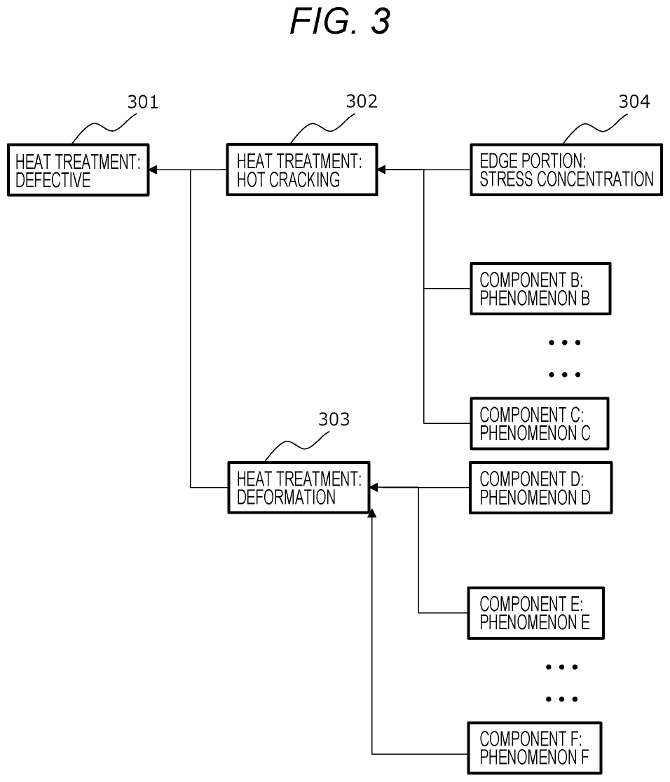

FIG. 3 illustrates a further specific example thereof, and, this example illustrates a causal relationship of a defect related to heat treatment. For example, FIG. 3 illustrates that factors of “heat treatment: defective” 301 include “heat treatment: hot cracking” 302 and “heat treatment: deformation” 303, and further, factors of “heat treatment: hot cracking” 302 includes “edge portion: stress concentration” 304 and the like (similarly to FIG. 2, these are associated with an AND condition or an OR condition, but are not illustrated).

As described above, it is assumed that the factor in the causal model is expressed in the form of “component (alternatively, processing content, method, characteristic shape, and partial shape): phenomenon”.

### Attribute Information Extraction Processing

The attribute information extraction unit 110 extracts, from the 3D CAD model received by the 3D CAD model input unit 109, attribute information expressing features, constituent elements, and the like of a product, such as a product name, a component name, an attribute name, and a characteristic shape.

As the 3D CAD model in the present example, for example, it is assumed that information such as attribute names such as a product name, a component name, a dimension, a tolerance, and a material name is embedded in a three-dimensional shape model created by 3D CAD, such as a 3DA model (3D annotated models). Then, the embedded product name, component name, attribute name, and the like can be extracted by using an additional information confirmation function or the like included in 3D CAD software.

In addition, the characteristic shape can be extracted from the 3D CAD model, for example, by causing a characteristic shape to be recognized by using a connection relationship between surfaces in 3D CAD data, or by extracting image data from the 3D CAD data and confirming whether or not there is a part matching with a characteristic shape defined in advance by using an automatic image recognition technique or the like.

Furthermore, in a case where information regarding the characteristic shape is embedded as additional information of the 3DA model or the like, the information may be extracted by using the function of the 3D CAD software as described above. Note that “edge portion”, “boss”, “rib”, and the like are conceivable as an example of the characteristic shape.

### Relevance Degree Evaluation Processing

The relevance degree evaluation unit 111 evaluates a relevance degree between each factor of the causal model stored in the causal model database 114 and a product as a design target based on the attribute information extracted by the attribute information extraction unit 110. As a result, among the factors (causal relationships) of the causal model, only factors related to the design target (factors having a high relevance degree) can be presented to the user. Two methods for evaluating the relevance degree are conceivable.

The first method is a method in which the attribute information extracted by the attribute information extraction unit 110 is compared with information included in each factor of the causal model, and, if there is a matching factor, this factor is evaluated to have a high relevance degree.

For example, a case where the causal model illustrated in FIG. 3 is stored in the causal model database 114 is conceivable. The components of the causal model include characteristic shapes such as “edge portion”, “component B”, “component C”, “component D”, “component E”, and “component F”, and a factor related to the component.

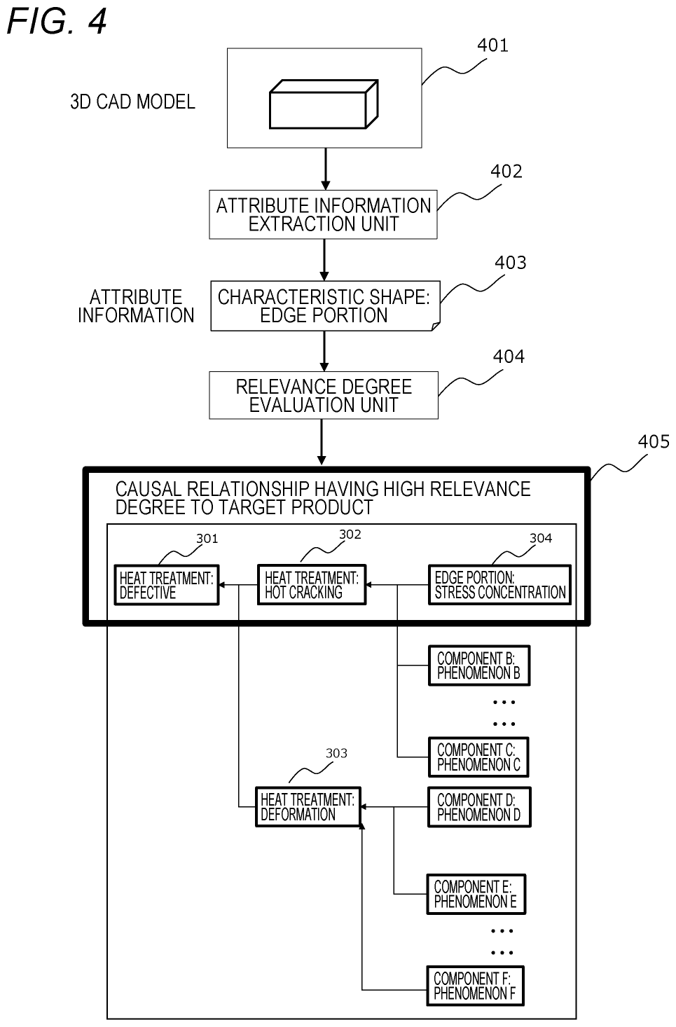

In addition, FIG. 4 is a diagram for describing the flow of processing of presenting a causal relationship having a high relevance degree to the target product, and it is assumed that the attribute information extraction unit 402 extracts “edge portion” 403 as the characteristic shape from the 3D CAD model as indicated by the reference signs 401.

The relevance degree evaluation unit 404 performs comparison with each factor of the causal model illustrated in FIG. 3, and evaluates a factor including the characteristic shape “edge portion” as a causal relationship having a high relevance degree. That is, in the causal model illustrated in FIG. 3, causal relationship portions of < “heat treatment: defective” 301←“heat treatment: hot cracking” 302←“edge portion: stress concentration” 304> is presented to a designer as a causal relationship 405 having a high relevance degree.

As a result, it is possible to make the user aware that, for a product having an edge portion, hot cracking may occur during heat treatment due to stress concentration, and a defect may occur in the heat treatment.

The second method is a method of evaluating the relevance degree between the attribute information extracted by the attribute information extraction unit 110 and the information included in each factor of the causal model based on a co-occurrence frequency in the defect information stored in the defect information database. Here, the co-occurrence frequency is a frequency at which two certain keywords appear in one document. As a result, it is possible to evaluate the relevance degree between the two keywords.

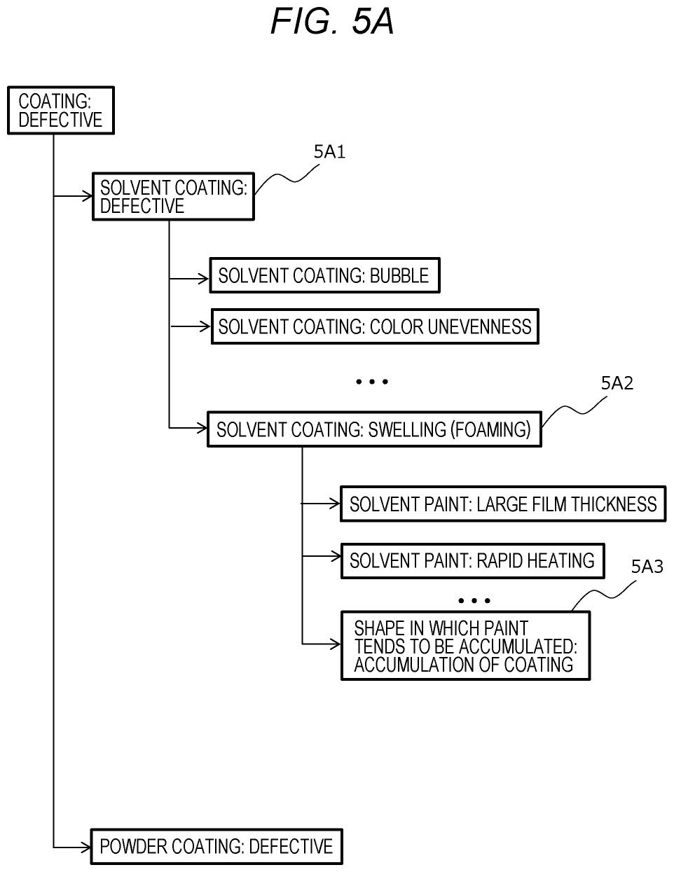

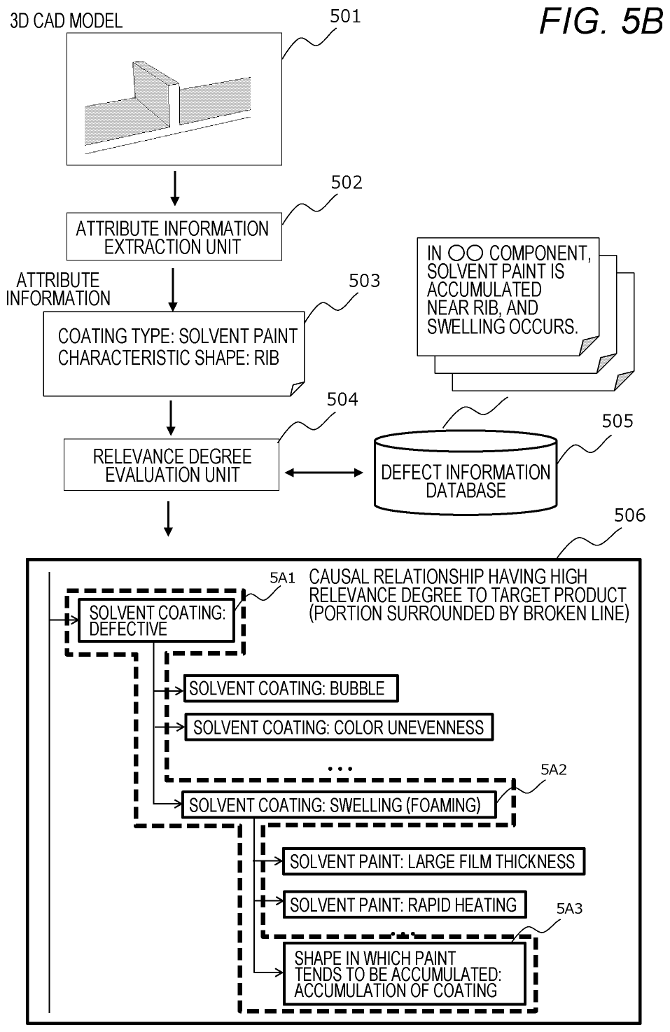

For example, a case where the causal model as illustrated in FIG. 5A is stored in the causal model database 114 is conceivable. The components of the causal model include causal processes and shapes such as “solvent coating”, “solvent paint”, and “shape in which a paint tends to be accumulated”.

In addition, FIG. 5B is a diagram for describing the flow of processing of presenting a causal relationship having a high relevance degree with the target product based on the co-occurrence frequency. It is assumed that the attribute information extraction unit 502 extracts “solvent paint” as a coating type and “rib” 503 as the characteristic shape from the 3D CAD model as indicated by the reference sign 501.

Further, it is also assumed that “in 00 component, the solvent paint is accumulated near the rib, and swelling has occurred.” is described in the defect information stored in the defect information database 505.

In the first method described above, the attribute information extracted by the attribute information extraction unit 110 is compared with information included in each factor of the causal model, and, if there is a matching factor, this factor is evaluated to have a high relevance degree. However, in this method, if there is a relationship in practice, but the expressions do not completely match, it is not evaluated that there is a relevance degree.

On the other hand, in the second method using the co-occurrence frequency, if complete matching is not made, but there is defect information in which both the attribute information extracted by the attribute information extraction unit 110 (502 in FIG. 5B) and the information included in each factor of the causal model are described, it can be evaluated that there is a relationship between the attribute information and each factor of the causal model.

In the causal model of FIG. 5A, there is the factor of “solvent coating: swelling (foaming)” 5A2←“shape in which a paint tends to be accumulated: accumulation of coating” 5A3 as having a relationship with the defect of solvent coating (5A1), but, here, “rib”, which is the attribute information extracted by the attribute information extraction unit 110 (502), is not described.

However, when the relevance degree evaluation unit 504 refers to “in OO component, the solvent paint is accumulated near the rib, and swelling has occurred.”, which is the description of the defect information, in FIG. 5B, the words of “solvent paint” and “rib”, which are the attribute information 503, and “swelling” of the factor “5A2” and “accumulation” of the factor “5A3” of the causal model are included, and it can be evaluated that these have a relationship (a portion surrounded by the broken line of 506).

Note that, here, for convenience of description, both the defect information and the causal relationship having a high relevance degree have been described in single case. However, there are cases where there are a plurality of pieces of defect information and where there are a plurality of related causal relationship candidates. In such cases, the strength of the relevance of each causal relationship is evaluated by the number of pieces of defect information (co-occurrence frequency) including both the attribute information and the information of each factor of the causal model.

That is, in the first method, evaluation is performed in two stages of matching and non-matching, but in the second method, evaluation is performed by the number of corresponding pieces of defect information (co-occurrence frequency). Thus, the relevance degree can be evaluated in a plurality of stages in the form of relevance degree. For example, evaluation may be performed in three stages of the relevance degree such as “high”, “middle”, and “low”, or may be expressed as a numerical value such as “0 (not related) to 10 (very high relevance degree)”. That is, in a case where there is a plurality of related objects, it is possible to evaluate and compare the strength of the relation among the related objects, and it is possible to present the related objects starting from the related object having the larger strength.

### Importance Degree Evaluation Processing

For each factor of the causal model, the importance degree evaluation unit 112 obtains what type of defect occurs in the product due to the factor by searching the causal model stored in the causal model database 114 from the cause side to the result side, and evaluates an importance from the defect occurring in the product.

For example, it is assumed that a causal model having a plurality of causal relationships including “screw: broken” is stored in the causal model database 114. Since the causal relationship of the defect is described in the causal model, it is possible to investigate what type of result is generated by “screw: broken” by searching from “screw: broken” to the result side.

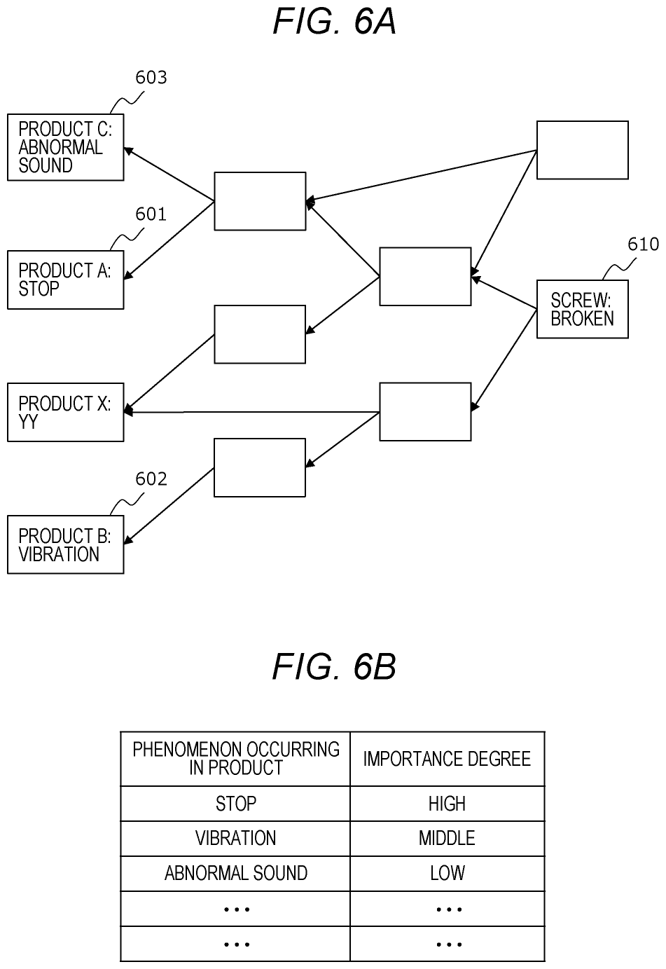

FIG. 6A is an example of such a causal model, and it can be seen that, if factors of the causal relationship of “product A: stop” 601 includes “screw: broken” 610, “screw: broken” 610 leads to “product A: stop” 601. In the similar manner, it can be seen that “screw: broken” 610 can lead to results such as “product B: vibration” 602 and “product C: abnormal sound” 603.

As described above, even due to the same “screw: broken” 610, the phenomenon that can occur as a result can vary depending on the product. Therefore, by specifying a product name from the attribute information extracted by the attribute information extraction unit 110 and performing comparison with the product name, it is possible to narrow down what type of phenomenon can occur as a result in the product as the design target.

In the case of the present example, if the attribute information extracted by the attribute information extraction unit 110 is “product A”, the phenomenon that can occur as a result is “product A: stop” 601. In addition, if the extracted attribute information is “product C”, the phenomenon that can occur as a result is “product C: abnormal sound” 603.

Then, for these phenomena, the importance degree is determined in advance. For example, as illustrated in FIG. 6B, since the stop of the product has a large influence, the importance degree of “stop” is determined to be high, the importance degree of “vibration” is determined to be middle, and the importance degree of “abnormal sound” is determined to be low. The importance degree is evaluated based on a relationship between the phenomenon occurring as a result and the importance degree. For example, if the phenomenon occurring as a result is “product A: stop”, the importance degree is “high”.

This makes it possible to clearly indicate the importance degree (severity) of the phenomenon (defect) that can occur as a result to the user, so that the user can adopt an action in consideration of the priority or the urgency for the measure.

Further, the importance degree may be expressed numerically instead of being evaluated as “high”, “middle”, or “low”. For example, by defining, in advance, the importance degree “high” as “10”, the importance degree “middle” as “5”, and the importance degree “low” as “1”, and the importance degree of other events located therebetween as “2 to 4, 6 to 9”, it is possible to present the importance degree to the user in more detail.

Furthermore, it is also possible to present a causal relationship having a high index to the user by using an index obtained by multiplying the above-described quantified relevance degree by the quantified importance degree.

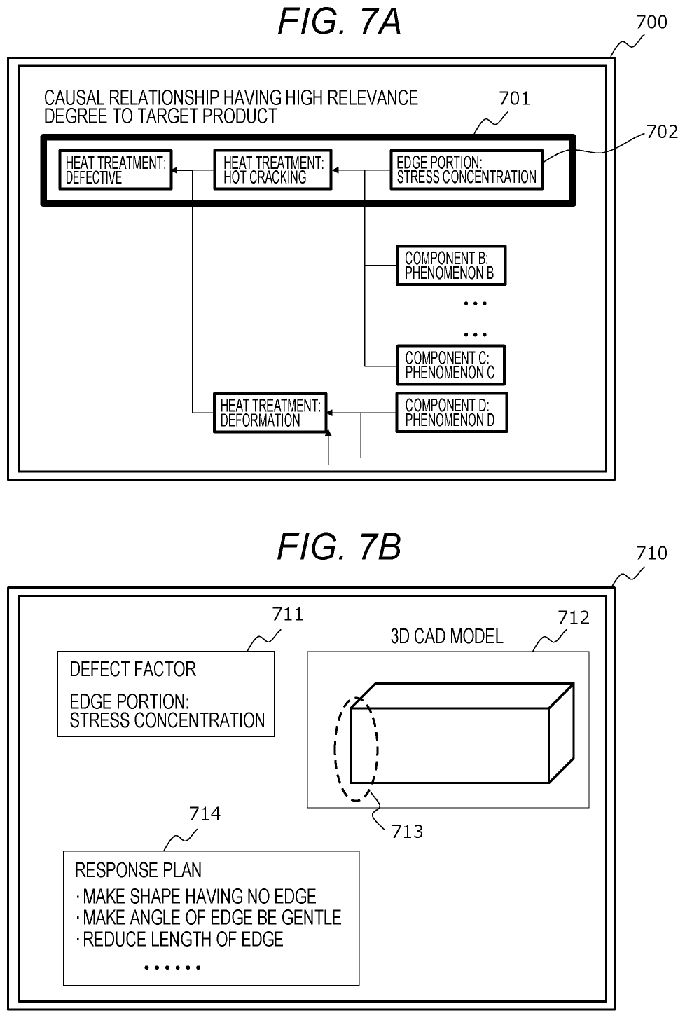

Note that the defect factor and the proposed measure are stored in association with each other, and, in addition to the defect factor, the proposed measure when the defect factor has occurred is also presented to support an action for the defect factor. FIGS. 7A and 7B are screen display examples of defect factors and proposed measures in the output device 106 (for example, a display device). In a screen display example 700 of FIG. 7A, in the causal model illustrated in FIG. 3, a portion of a causal relationship 701 evaluated to have a relationship or have a high relevance degree is displayed in a state of being surrounded by a thick line, so that it is possible to confirm which causal relationship is particularly related in the causal model.

Further, when the portion of “edge portion: stress concentration” 702, which is the factor thereof, is clicked with a mouse or the like of the input device 105, a detail screen 710 illustrated in FIG. 7B is displayed.

On the detail screen 710, “edge portion: stress concentration” 711 is displayed as the clicked defect factor, and a the 3D CAD model 712 and the corresponding portion 713 are displayed in a state of being surrounded by a broken line or the like, so that the user can visually confirm where the defect can occur in the 3D CAD model.

In addition, since a response plan 714 for the defect factor is also displayed, it is possible to improve the accuracy and convenience of the design work of the user.

As described above, according to the present example, for the design model generated by the design tool, the attribute information regarding the product as the design target, such as the characteristic shape and the attribute information, can be extracted, and compared with the causal relationship of the defect defined in advance, the relevance degree and the importance degree can be evaluated, and the defect factor having the high relevance degree and the high importance degree can be narrowed down and presented.

### Example 2

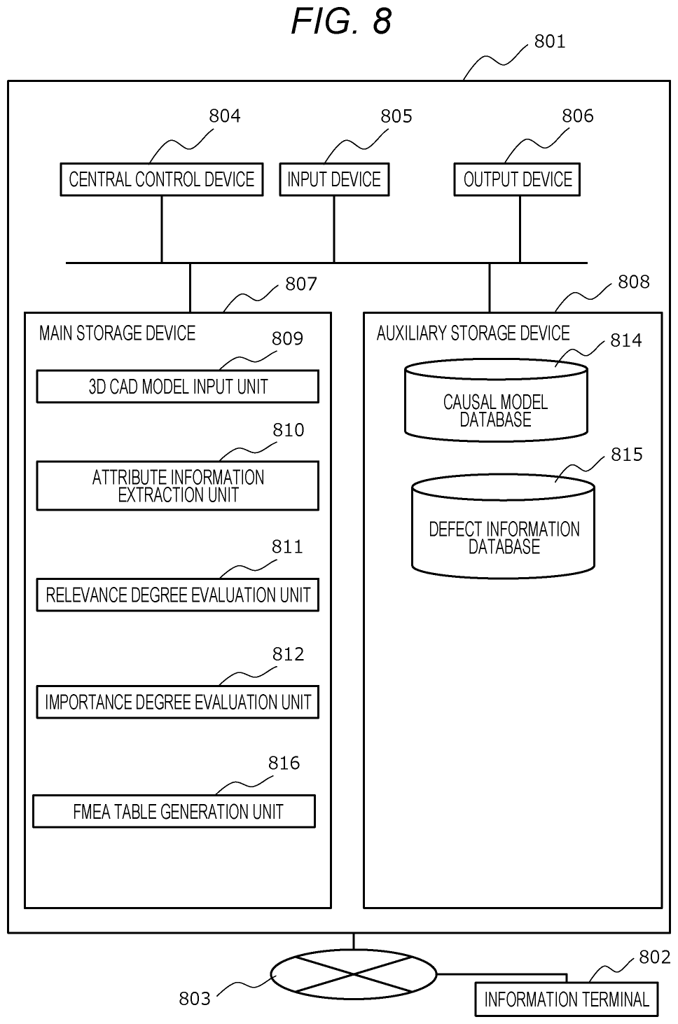

FIG. 8 illustrates a form of the present example. The basic configuration of a design support device 801 is similar to the configuration of Example 1 illustrated in FIG. 1. The design support device 801 is configured to further include an FMEA table generation unit 816, and supports FMEA in design activities of a user.

Here, the failure mode and effects analysis (FMEA) predicts a phenomenon related to a possible defect for a component as a design target at the time of design based on an FMEA table, and evaluates an influence of the phenomenon on a unit and an influence on a higher-level product. Then, this is a method of preventing an occurrence of a defect by taking a measure in advance for a design target evaluated to have a large influence.

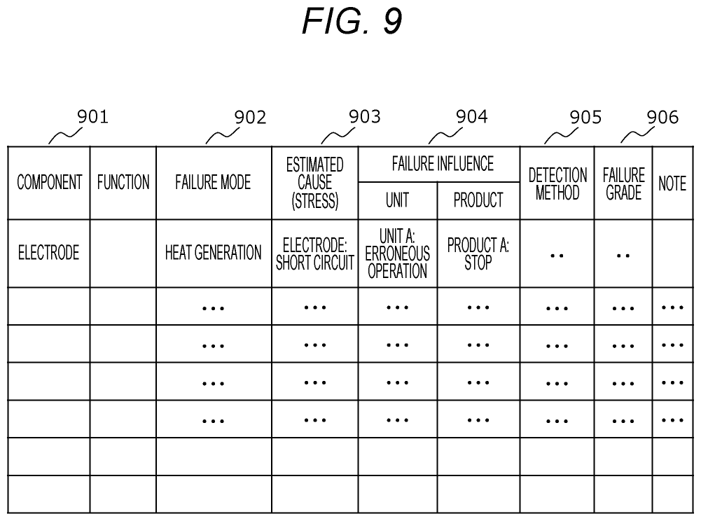

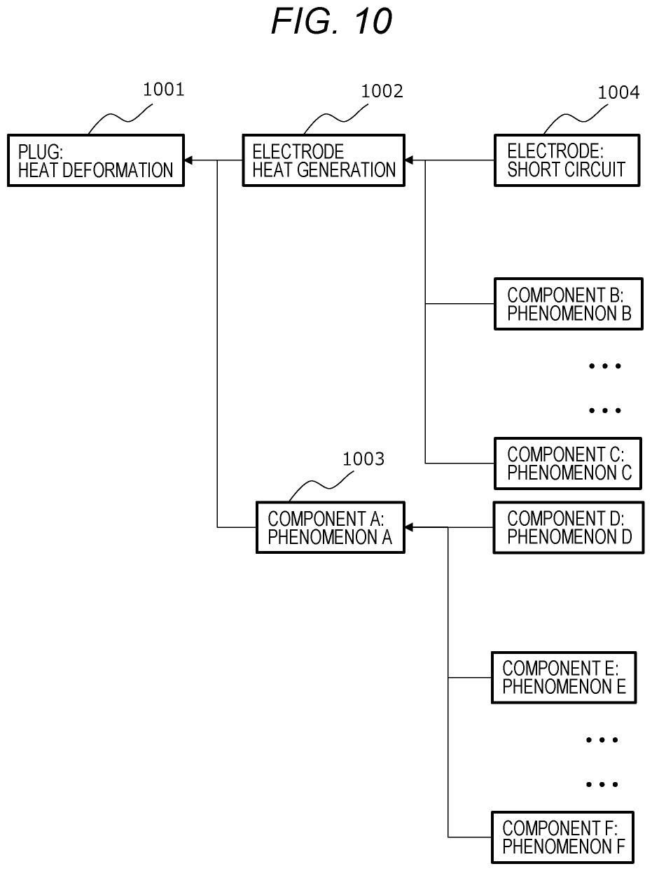

FIG. 9 illustrates an example of the FMEA table. A component column 901 is a component name as an analysis target, a failure mode 902 is a phenomenon name related to a possible defect in the component, and an estimated cause (stress) column 903 is a factor thereof. Further, a failure influence column 904 is an influence of the failure on the unit and the product for each unit and each product. In addition, a detection method (detection difficulty level) 905 is a method that quantifies the difficulty of detecting a failure, and a failure grade (risk priority number; RPN) 906 is obtained by multiplying the numerical value of the failure influence by the numerical value of the detection method, and indicates the degree of necessity of the pre-measure.

Such an FMEA table is effective for verifying the accuracy and the validity of the design work in advance, but, in a case where the FMEA table is created by an individual user, it is not always easy to identify a phenomenon name and an estimated cause regarding a defect with respect to a component intended to be analyzed and to evaluate the influence of the failure.

That is, there is a concern that omission occurs, depending on an individual user, in identifying the phenomenon name and the estimated cause regarding the defect with respect to the component intended to be analyzed, variation occurs depending on the individual user, and furthermore, significant man-hours are required for the creation of the FMEA table, and the efficiency is rather lowered. In addition, in the evaluation of the influence of the failure, similarly, it is conceivable that variation occurs depending on the individual user or a significant man-hour is required.

The design support device 801 in the present example makes it possible to create such an FMEA table. For example, the causal model illustrated in FIG. 8 is conceivable. This represents a causal relationship with respect to heat deformation of a plug. A causal relationship in which, for example, heat generation 1002 occurs in an electrode due to a short circuit 1004 of the electrode, and the plug is subjected to heat deformation 1001 is described in this causal model.

In a case where “electrode” is exemplified as the component intended to be analyzed, by using this causal model, the FMEA table generation unit 816 extracts “heat generation” as a defect phenomenon occurring in “electrode” and further extracts “electrode: short circuit” as an estimated cause.

Furthermore, by using the importance degree evaluation unit 812, what type of defect occurs in the product or unit due to each factor of the causal model can be extracted by the similar method to described in Example 1.

As a result, the FMEA table generation unit 816 inputs the failure mode column 902, the estimated cause (stress) column 903, and the failure influence column 904 of the FMEA table illustrated in FIG. 9. In addition, regarding the detection method 905, the difficulty of detection of various defect phenomena is defined in advance in a correspondence table (not illustrated) or the like, and can be input by referring to the correspondence table or the like. Furthermore, since the failure influence 904 can also be quantified by preparing a table or the like in which the influence degrees of various failures are quantified in advance, the failure grade 906 can also be input by being multiplied by the numerical value of the detection method 905 described above. In addition, the FMEA table in which each value is input can be displayed by the output device 106 or the like.

Note that the present example is not limited to the creation of the FMEA table, and can also be applied to the creation of a table for examination used when design review based on failure mode (DRBEM) is performed.

As described above, according to the present example, in creating the FMEA table, it is possible to reduce omission and variation by an individual user and to reduce man-hours.

### Example 3

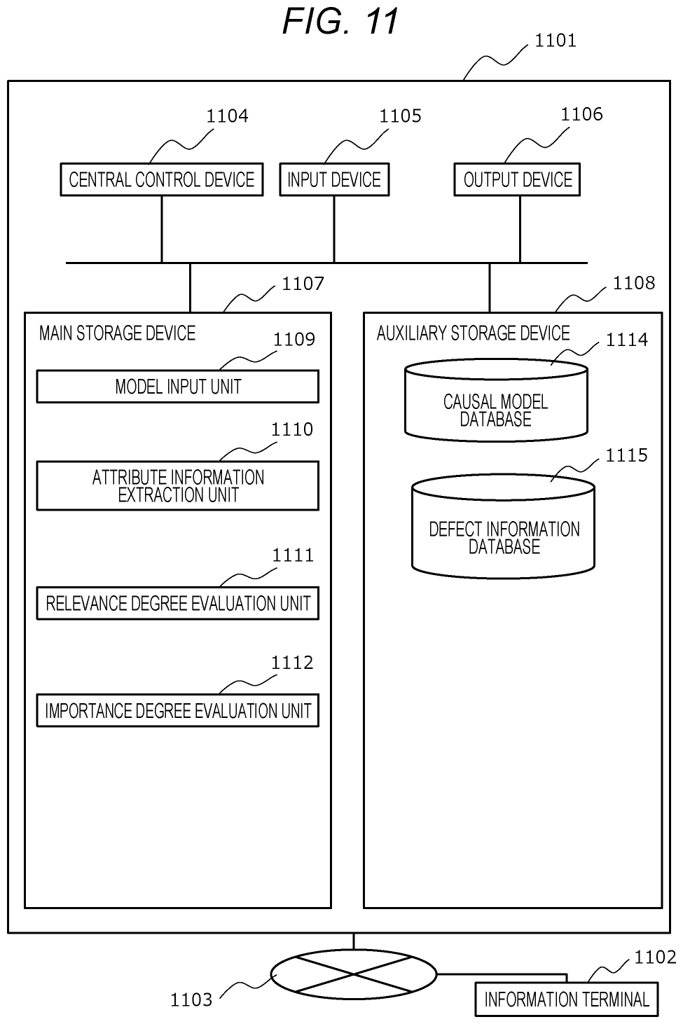

FIG. 11 illustrates a form of the present example. The basic configuration of a design support device 1101 is similar to the configuration of Example 1 illustrated in FIG. 1, but, in Example 1, the attribute information is extracted from the 3D CAD model received by the “3D CAD model input unit” 109.

On the other hand, in the present example, the “3D CAD model input unit” 109 is replaced with a “model input unit” 1109 obtained by extending the “3D CAD model input unit” 109, and not only the 3D CAD model but also other models can be input, and an attribute information extraction unit 1110 can extract the attribute information from the other models. Examples of other models include a dependency structure matrix (DSM), quality function deployment (QFD), and model-based systems engineering (MBSE).

DSM represents a dependency relationship between components of a product on a matrix. In addition, QFD expresses a relationship between a requirement and a function, and a relationship between a function and a component, on a matrix. Further, MBSE defines a structural diagram, a requirement diagram, a behavior diagram, and a parametric diagram by using the SysML language.

Here, the structural diagram is used to represent the structure of the system. The structural diagram can be used to express the system as a tree structure of constituent elements of the system or to express relationships between components.

The requirement diagram is a diagram that defines detailed functional requirements and non-functional requirements of the system. The request diagram is configured by relationships with requirement classes describing functional requirements and non-functional requirements.

Here, the functional requirement relates to a functional aspect among requirements for a system. The non-functional requirement relates to a requirement other than the functional aspect among the requirements for the system.

The behavior diagram is a diagram that defines a dynamic behavior of the system. The behavior diagram is configured by states and transitions. The parametric diagram is a diagram that defines constraints of the system, related values, and mathematical expressions.

The parametric diagram is further configured by a constraint block and a connector. The constraint block is a block in which constraints of the system, related values, and mathematical expressions are described. The related constraint blocks are joined by a connector based on the structure of the block created in a block definition diagram.

Each of DSM, QFD, and MBSE models includes information such as a product name, a component name, and an attribute, similarly to the 3D CAD model (3DA model). Therefore, the attribute information extraction unit 1110 in the present example also extracts the attribute information from these models. As a result, it is possible to support the utilization of the defect knowledge by providing the defect knowledge related to the design target to the user who designs by using the model other than the 3D CAD model, such as DSM, QFD, and MBSE.

### Reference Signs List

101 design support device
102 information terminal
103 network
104 central control device
105 input device
106 output device
107 main storage device
108 auxiliary storage device
109 3D CAD model input unit
110 attribute information extraction unit
111 relevance degree evaluation unit
112 importance degree evaluation unit
114 causal model database
115 defect information database

1. A design support device that evaluates a defect that can occur in a design model generated by a design tool and a factor of the defect, the design support device comprising:
a causal model database that stores a causal model expressing a defect that can occur in a design target by using a causal relationship in which, due to a certain phenomenon, another phenomenon occurs;
an attribute information extraction unit that extracts attribute information regarding a design target from the design model; and
a relevance degree evaluation unit that extracts, for the causal model, a causal relationship including a content matching with the extracted attribute information as a causal relationship having a high relevance degree to the design model.

2. The design support device according to claim 1, wherein
in the causal model, a target object and a phenomenon name of the target object is defined as a one element and a causal relationship of a defect is expressed in order of causality in a linked manner, and
the target object includes any one of a product name, a component name or a part name, and a characteristic shape.

3. The design support device according to claim 2, wherein the design model is a 3DA model.

4. The design support device according to claim 2, wherein the design model is any one of DSM, QFD, and MBSE.

5. The design support device according to claim 3, further comprising a defect information database that stores defect information in which a content of a defect that has occurred in the design target is recorded, wherein the relevance degree evaluation unit evaluates a relevance degree between an element of each causal relationship included in the causal model and the extracted attribute information based on a co-occurrence frequency in the defect information.

6. The design support device according to claim 3, further comprising an importance degree evaluation unit that searches for a defect occurring in a product including a specific component by searching from a cause side to a result side for a causal relationship with respect to a factor of the specific component in the causal model, and evaluates the causal relationship as an importance degree given to the product based on an importance degree determined in advance for each defect.

7. The design support device according to claim 6, further comprising a FMEA table generation unit that inputs values of a failure mode column, an estimated cause column, and a failure influence column in an FMEA table.

8. The design support device according to claim 6, further comprising a display unit that distinguishes and presents a causal relationship evaluated to be relevant or have a high relevance degree by the relevance degree evaluation unit.

9. The design support device according to claim 8, wherein the display unit displays a defect factor in the causal relationship and a corresponding portion of the design model.

10. The design support device according to claim 9, wherein the display unit displays a response plan to the defect factor.
